(19) United States
(12) Patent Application Publication
(10) Pub. No.: US 2026/0070746 A1
(43) Pub. Date: Mar. 12, 2026

(54) VACUUM LIFTING ARRANGEMENT AND LIFTING TUBE FOR USE THEREIN

(71) Applicant: TAWI AKTIEBOLAG, Kungsbacka (SE)

(72) Inventors: Petter TOFT MORÉN, Kungsbacka (SE); Jonas WOLMESJÖ, Träslövsläge (SE)

(21) Appl. No.: 19/108,505

(22) PCT Filed: May 23, 2023
(86) PCT No.: PCT/EP2023/063791

§ 371 Date: Mar. 4, 2025

(30) Foreign Application Priority Data
Sep. 5, 2022 (SE) 22193959.8

(51) Int. Cl. B65G 47/91

(52) U.S. Cl. CPC B65G 47/91; B65G 2201/0276

(57) ABSTRACT

A vacuum lifting arrangement having a lifting tube and a suction foot for engaging with an object to be lifted, is disclosed, said vacuum lifting arrangement having a pneumatic valve fluidly connected to ambient air, wherein, during operation of the vacuum lifting arrangement, when an object is not engaged with the suction foot, an air-flow from the suction foot into the lifting tube is prevented by the valve which is in a closed position, and, upon generation in the suction foot of a pressure lower than the surrounding pressure, e.g. due to engagement with an object to be lifted, the valve will be in an open position, allowing an-air flow from the suction foot into the lifting tube. A lifting tube comprising a pneumatic valve for use in the lifting arrangement is also disclosed.

### FIELD OF THE INVENTION

The present invention relates to a vacuum lifting arrangement having a lifting tube and a suction foot for engaging with an object to lifted, having a pneumatic valve fluidly connected to ambient air, wherein, during operation of the arrangement, when an object is not engaged with the suction foot, an air-flow from the suction foot into the lifting tube is prevented by the valve which will be in its closed position, and, upon generation in the suction foot of a pressure lower than ambient pressure, e.g. due to engagement with an object to be lifted, the valve will be in an open position, allowing an-air flow from the suction foot into the lifting tube. The invention also relates to a lifting tube comprising the inventive pneumatic valve for use in the lifting arrangement.

### BACKGROUND ART

Vacuum lifting arrangements comprising a lifting tube and a suction foot are known in the art and are used to assist an operator in lifting objects, especially heavy objects. A problem with lifting devices is that air passing through the suction foot, typically during instances when an object is not engaged, generates noise, which is disturbing to the operator, or even damaging to the hearing of the operator, unless hearing protection is being used by the operator.

WO 2021/145815 discloses a vacuum lifting arrangement comprising a flexible lifting tube and a suction foot which can be raised and lowered by means of the flexible lifting tube being retractable and extendible. An operator uses operating means on the housing of the lifting foot to raise and lower the suction foot and to release the load from the suction foot, which operating means are connected to a valve arrangement which controls the vertical position of the suction foot as well as controls the release of a load when attached to the suction foot. By placing the valve arrangement downstream of the suction foot, the distance to the valve arrangement from the operator can be increased and the noise level reduced.

WO 2021/145815 discloses that further reduction of noise from the entire vacuum lifting arrangement can be obtained when the suction foot comprises a movable valve plate arranged to close against a seal during operation of the vacuum pump when no load is attached to the suction foot. The movable plate is pressed against the seal by the vacuum generated by the vacuum pump during operation when no load is attached to the suction foot.

The present invention provides for a noise-reducing alternative solution to the movable valve plate of WO 2021/145815.

### SUMMARY OF THE INVENTION

The present inventor has found that, during operation of a vacuum lifting arrangement, the pressure difference between surrounding air of atmospheric pressure, and a lower pressure inside the suction foot, can be used for keeping a valve in an open position. The inventive valve, which is referred to herein as a load valve, connects an inner volume of the lifting tube with an inner volume of the suction foot. In an open position of the load valve, a flow of air through the load valve from the suction foot to the lifting tube is enabled. In a closed position of the load valve, the load valve prevents a flow of air through the load valve from the suction foot to the lifting tube. The load valve is preferably configured to be in an open position when the pressure in the lifting tube is essentially ambient, e.g. instances of non-activity of the vacuum lifting arrangement. During operation, without an object to be lifted being engaged with the suction foot, the inventive load valve will close due to the drag caused by the air flowing through the load valve. During operation of the inventive vacuum lifting arrangement, a reduced pressure in the suction foot, which is required for the load valve to be in the open position during operation, can be obtained in two different ways: either by means of an opening allowing for a minor flow of air from the suction foot to the lifting tube; or by means of a flow valve located upstream of the inventive load valve, which flow valve can be used for opening the inventive load valve from a closed position by allowing surrounding air into the lifting tube so that the pressure inside the lifting tube becomes essentially ambient, thereby opening the inventive load valve. Preferably, both an opening and a flow valve are provided in the inventive vacuum lifting arrangement.

Accordingly, in one aspect the invention relates to a vacuum lifting arrangement 10, comprising: a vacuum source 100; a suction foot 20 having an upper end 22, and a lower end 24 configured to engage with an object 200 to be lifted; a lifting tube 30 having a first end 32 and a second end 34, the first end of the lifting tube being sealingly attached to the upper end of the suction foot, and the second end of the lifting tube being configured to be operatively connected to the vacuum source; a load valve 40 comprising a valve member 41 configured to be movable between a closed position, in which closed position the movable valve member prevents an air flow from an inner volume 26 of the suction foot through the load valve into an inner volume 36 of the lifting tube, and an open position, in which open position the movable valve member enables an air flow from the inner volume 26 of the suction foot into the inner volume 36 of the lifting tube through the load valve, which load valve is disposed inside the upper end of the suction foot, or, inside the lifting tube, and which load valve is configured to be in the open position in an instance of rest of the vacuum lifting arrangement, wherein the load valve 40 is pneumatic and exhibits a pneumatic cylinder 42 having a high-pressure side 43 configured to stand in fluid connection with ambient air 80, and a low-pressure side 45 configured to stand in fluid connection with the inner volume 36 of the lifting tube, in which cylinder a movable member 46 is displaced, which movable member is configured to be movable in a direction between the high-pressure side and low-pressure side and is operatively connected to the movable valve member 41, and wherein an opening 60 is provided fluidly connecting the inner volume 26 of the suction foot 20 with the inner volume 36 of the suction tube 30.

In a preferred embodiment, a flow valve 50 is provided upstream of the load valve 40, which flow valve is configured to connect the inner volume 36 of the lifting tube 30 to ambient air 80.

In another aspect, the present invention relates to a similar vacuum lifting arrangement 10, wherein, instead of an opening 60 being provided, a flow valve 50 is provided upstream of the load valve 40, which flow valve is configured to connect the inner volume 36 of the lifting tube 30 to ambient air 80.

In a further aspect, the present invention relates to a lifting tube 30 comprising the load valve 40, to which lifting tube a suction foot 20 is attached, for use in the above lifting arrangements.

Further embodiments and advantages of the invention will be apparent from the following detailed description and appended claims.

### BRIEF DESCRIPTION OF THE ATTACHED DRAWINGS

FIG. 1 shows a schematic overview of a preferred embodiment of the inventive vacuum lifting arrangement 10 which comprises a flexible lifting tube 30 which can be extended and retracted, an operator of the arrangement, and a cardboard box 200 to be lifted by the operator using the lifting arrangement.

FIG. 2 shows an enlarged partial view of the inventive vacuum lifting arrangement 10 shown in FIG. 1, the operator, and a cardboard box 200 to be lifted by the operator using the lifting arrangement.

FIG. 3 shows an enlarged view of detail view A in FIG. 2.

FIG. 4 shows an enlarged view along the section B-B of FIG. 3, wherein the load valve 40 is in its open position.

FIG. 5 shows an enlarged view of the embodiment shown in FIG. 4, wherein the load valve 40 is its closed position.

FIG. 6 shows an enlarged view of a similar embodiment as shown in FIGS. 4 and 5, wherein the load valve 40 additionally comprises a spring 44.

FIG. 7 shows an enlarged view of a similar embodiment as shown in FIGS. 4 and 5, wherein, additionally, an opening 60 fluidly connecting the inner volume 36 of the lifting tube and the inner volume 26 of the suction foot is provided.

FIG. 8 shows an enlarged view of a similar embodiment as shown in FIGS. 4 and 5, wherein, additionally, an opening 60 fluidly connecting the inner volume 36 of the lifting tube and the inner volume 26 of the suction foot, is provided in the movable valve member 41.

FIG. 9 shows an enlarged view of a similar embodiment as shown in FIGS. 4 and 5, wherein, additionally, an opening 60 fluidly connecting the inner volume 36 of the lifting tube and the inner volume 26 of the suction foot, is provided in the valve seat 48 of the load valve 40.

### DETAILED DESCRIPTION OF THE INVENTION

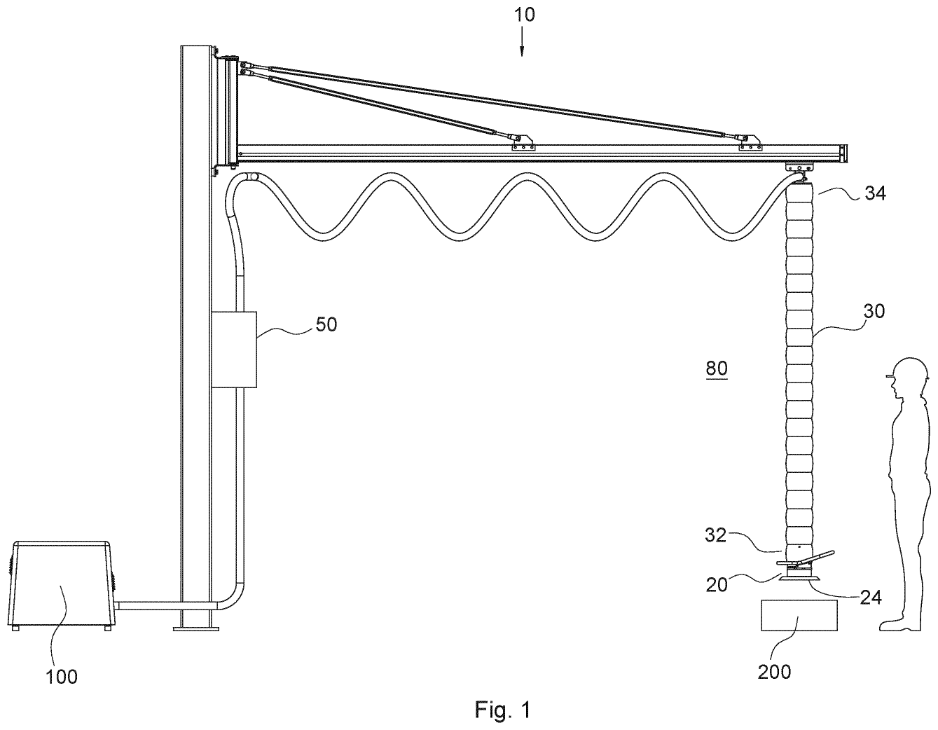

The present invention relates to a vacuum lifting arrangement 10, an embodiment of which is schematically shown in FIG. 1, having a lifting tube 30 and a suction foot 20 for engaging with an object 200 to lifted, said arrangement having a pneumatic load valve 40 fluidly connected to ambient air 80, wherein, during operation of the arrangement, when an object is not engaged with the suction foot, an air-flow from the suction foot into the lifting tube is prevented by the load valve which is in a closed position, and, upon generation in the suction foot of a pressure lower than the surrounding pressure, e.g. due to engagement with an object to be lifted, the load valve will be in an open position, allowing an air-flow from the suction foot into the lifting tube.

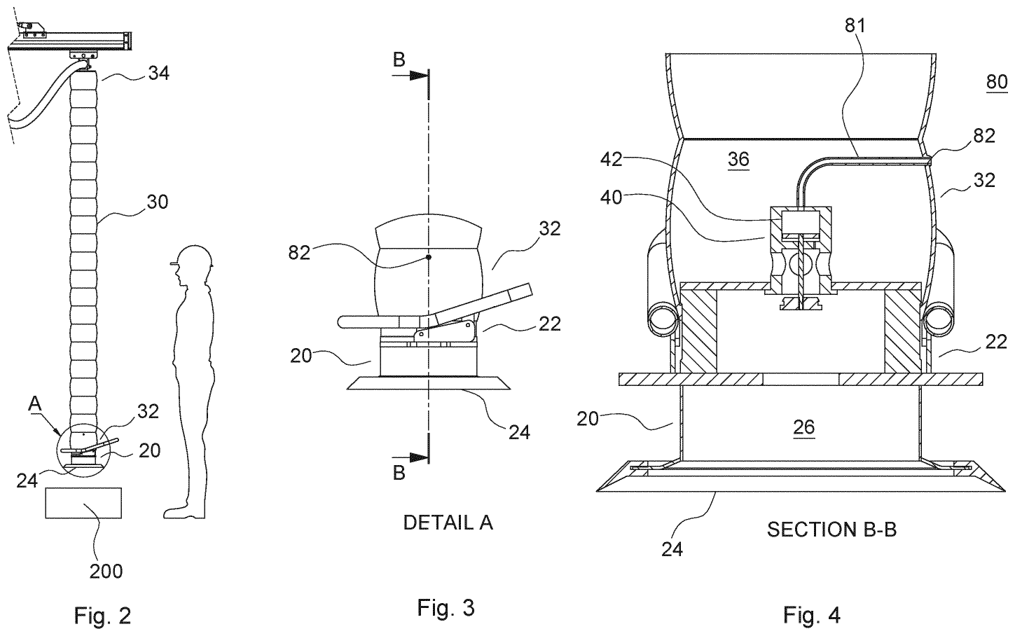

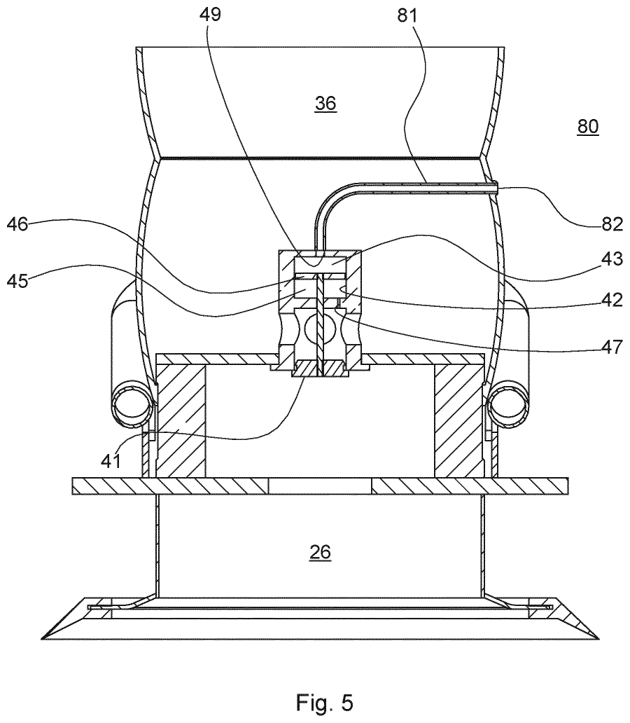

The load valve 40 is fluidly connected to ambient air 80 via the high-pressure side 43 of the pneumatic cylinder of the load valve. For this purpose, in one embodiment, such as shown in FIGS. 1-9, an opening 49 is provided in the high-pressure side 43 of the pneumatic cylinder of the load valve, to which opening a conduit 81 is attached, fluidly connecting the opening 49 with an opening 82 in the lifting tube 32, which latter opening enters into ambient air. During operation of the vacuum lifting arrangement 10, the high-pressure side 43 of the pneumatic cylinder of the load valve must remain fluidly connected to ambient air 80, i.e. must stand in fluid communication with ambient air 80, such that the pressure inside the pneumatic cylinder on the high-pressure side 43 will remain ambient. If desired, during periods of non-activity, however, an opening 82 to ambient air could be closed off if, such as by a cover, lid, plug or the like (not shown).

The present invention does not require pressurized air for controlling the load valve, and, consequently, the inventive load valve does not rely on pressurized air for opening of the valve, but merely on ambient fluid of ambient pressure for opening of the valve. In most operations the ambient fluid will be air and the ambient pressure will be atmospheric pressure.

The low-pressure side 45 of the pneumatic cylinder is fluidly connected to the inner volume 36 of the lifting tube. Thereby, the pressure in the low-pressure side of the pneumatic cylinder will be essentially the same as the current pressure in the lifting tube. For this purpose, in one embodiment, such as shown in FIGS. 4-9, an opening 47 is provided in the low-pressure side 45 of the pneumatic cylinder of the load valve, fluidly connecting the low-pressure side 45 of the pneumatic cylinder of the load valve 40 with the inner volume 36 of the suction tube 30.

In embodiments not having an upstream flow valve 50, an opening 60 must be provided, allowing, during operation of the vacuum lifting arrangement, for a minor flow of air from the suction foot to the lifting tube in an instance when the load valve 40 is in a closed position. The minor flow of air will serve to reduce the pressure in the suction foot when engaged with an object 200 to be lifted. When the pressure in the suction foot has been reduced below ambient pressure by means of the minor flow of air, load valve 40 will open due to the higher ambient pressure inside the pneumatic cylinder of the load valve. The more reduced the pressure in the suction foot, the higher the opening force of the pneumatic cylinder.

In preferred embodiments, both an opening 60 and a flow valve 50 are provided in the inventive vacuum lifting arrangement.

The purpose of an opening 60 is to allow for a minor flow of air through said opening when the load valve 40 is in a closed position.

When present, the opening 60 is preferably configured so as to, during operation, when the pressure in the lifting tube has been reduced and the drag on the valve member 41 has brought to load valve to its closed position, allow for reducing the pressure in the suction foot and thereby opening of the load valve 40 within 1 s, more preferably within 0.5 s from placing of the suction foot to a surface of an object 200 to be lifted.

A suitable cross-sectional area of the opening 60 is selected primarily depending on the overall volume of the suction foot.

The suction foot is preferably selected so as to exhibit an engagement surface area that is larger than the cross-sectional area of the lifting tube, more preferably the engagement surface area of the suction foot is at least 2.5 times the cross-sectional area of the lifting tube.

The suction foot 20 could be comprised of an array of a multitude of suction cups (not shown), such as e.g. used for lifting objects having a large lifting surface to be engaged by the suction foot.

The suction foot 20 is preferably detachable from the lifting tube 30, so as to be replacable. In such embodiments the load valve is preferably arranged inside the lifting tube, preferably in the first end 32 of the lifting tube.

While shown in the drawings (FIGS. 4-9) with reference to a piston, the movable member 46 in the pneumatic cylinder could alternatively be embodied as a membrane. Preferably, the movable member is a piston.

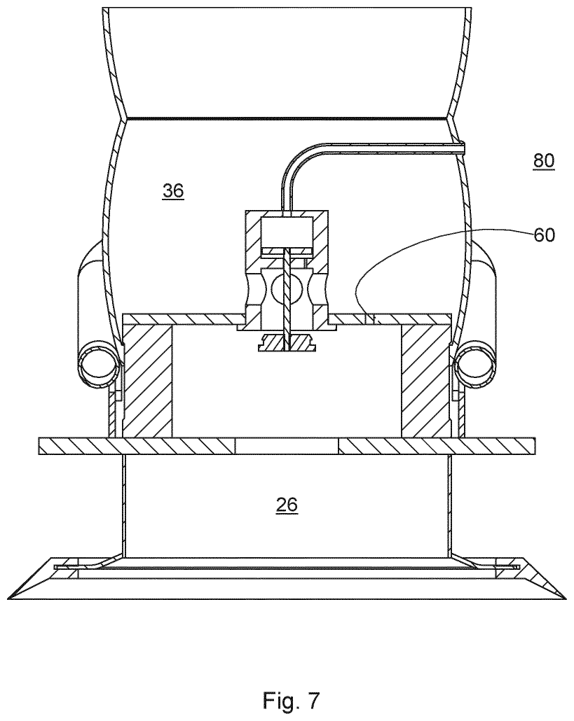

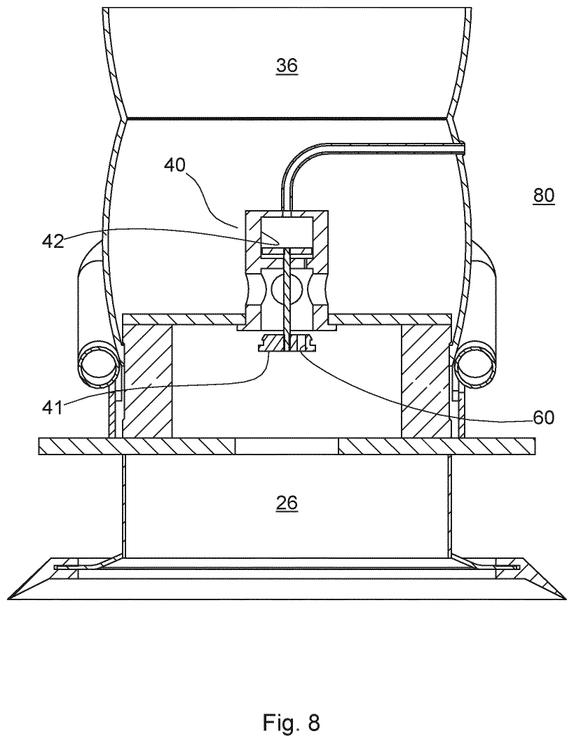

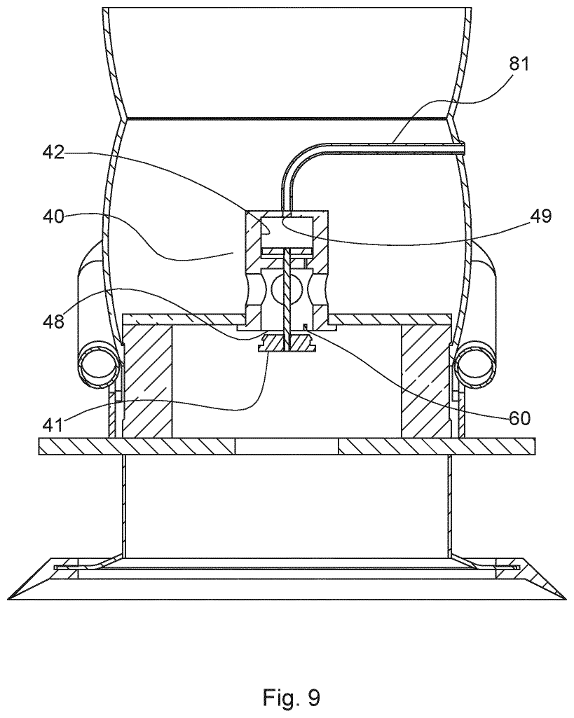

The opening 60 can be implemented in different ways according to the invention, some examples of which are shown in FIGS. 7-9: e.g. by a through bypass opening 60 fluidly connecting the inner volume 26 of suction foot 20 with the inner volume 36 of suction tube 30, through which bypass opening a minor flow of air can bypass the load valve when in its closed position, such as generally shown in FIG. 7; by a through bypass opening provided in the movable valve member 41, such as generally shown in FIG. 8; or, by a small recess or cut-out 60 provided in the valve seat 48 such as generally shown in FIG. 9, forming an open channel connecting the inner volume of suction foot 20 with the inner volume of suction tube 30 when valve 40 is in its closed position.

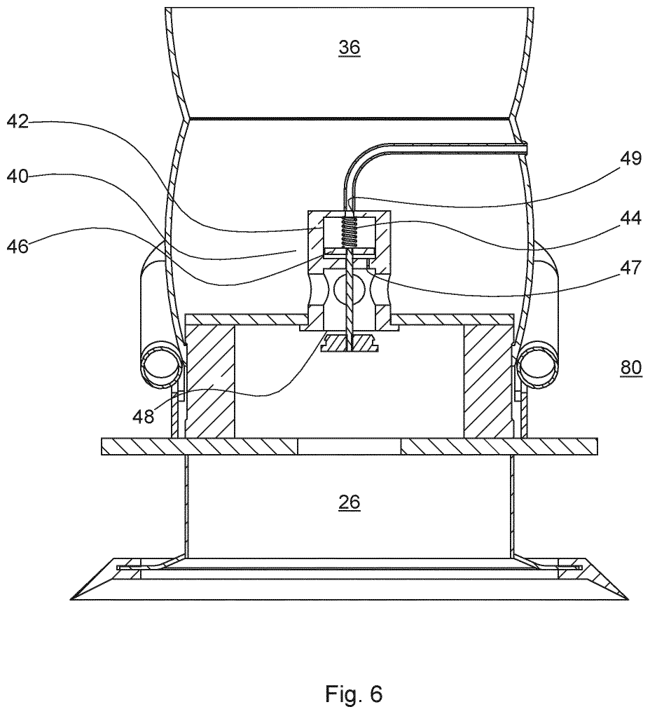

The valve 40 is configured to be in an open position in a state of rest of the vacuum lifting arrangement, i.e. when no vacuum is being generated in the lifting tube. For example, when the load valve is oriented in an essentially vertical direction, the weight of the movable valve member 41 can serve to bring the movable valve member into an open position of the load valve. A spring 44, as shown in FIG. 6, is preferably provided in the pneumatic cylinder of the inventive load valve, biasing the load valve in favour of an open position. Biasing the load valve in favour of an open position has the advantage of, during operation, when the valve is in its closed position and there is a reduced pressure in the lifting tube, reducing the pressure differential required between the high-pressure side and low-pressure for the load valve to open, as compared to a similar instance with a load valve not being biased in favour of an open position. Biasing the load valve in favour of an open position additionally has the advantage of, during operation, when the valve is in its open position and there is a reduced pressure in the lifting tube and suction foot and an object is engaged with the suction foot, allowing for a greater extent of leakage of ambient air into the suction foot before the load valve eventually moves to its closed position due to the drag on the movable valve member from the flow of leaking air passing through the flow valve.

When vacuum is connected to the lifting tube 30, such as via a flow valve 50, in an instance where no object is engaged with the suction foot, the drag caused by a flow of air flowing through the open load valve into the lifting tube from the suction foot will produce a drag acting on the movable valve member, which drag will tend to displace the movable valve member against the valve seat 48, thereby closing the valve. In addition thereto, a reduced pressure formed in the lifting tube will cause the higher ambient pressure to act on the movable valve member in a direction towards the valve seat, thereby closing the valve. In preferred embodiments, such as shown in FIGS. 1-9, the lifting tube 30 is flexible, e.g. so as to allow for the lifting tube to be extended and retracted. Such lifting tubes are known from the prior art, e.g. from WO 2021/145815, and will not be described in further detail herein.

The length of the lifting tube is not critical, and will primarily be dependent on the lifting height. Typically, the length of the lifting tube in its fully extended state will range from 0.5 m to 4 m, such as from about 1.7 m to about 2.5 m.

A flow valve 50 is preferably provided upstream of the load valve 40, especially in embodiments with a flexible lifting tube, in which latter case the flow valve is preferably configured to control the vertical position of the suction foot as known in the art, by allowing a controllable flow of ambient air into the inner volume 36 of the lifting tube 30 via said flow valve.

By virtue of the opening force of the pneumatic cylinder of the present invention, a relatively high leakage between the suction foot and an object engaged therewith can be tolerated, since the inventive load valve will remain open, and resist drag caused by a flow of air passing through the load valve as long a reduced pressure prevails in the suction foot, the inner volume of which is fluidly connected with the low-pressure side of the pneumatic cylinder of the load valve. Accordingly, the present invention allows for handling of objects with leaking surfaces, or an object, e.g. a package or parcel, having a damaged surface.

While the inventive load valve 40, when disposed inside the lifting tube, could be placed at any height therein, it preferred that the load valve be placed at a lower height therein, i.e. closer to the upper end 22 of the suction foot 20, such as in the first end 32 of the lifting tube 30, since such positioning will reduce the volume that needs to be evacuated in order to lift an object with the inventive lifting arrangement. A reduced volume enables reducing the response time. In embodiments where the lifting tube is extendible/retractable, a lower position of the load valve moreover enables an increased length of retraction of the lifting tube, and thereby higher lifting operations.

The pneumatic valve is preferably configured so that a direction of movement of the movable valve member 41 of the pneumatic valve is essentially parallel with a general longitudinal direction of the lifting tube and vertical.

### LIST OF REFERENCE NUMERALS USED

10 vacuum lifting arrangement
20 suction foot
22 upper end of suction foot
24 lower end of suction foot
26 inner volume of suction foot
30 lifting tube
32 first end of lifting tube
34 second end lifting tube
36 inner volume of lifting tube
40 pneumatic valve, or load valve
41 movable opening and closing load valve member
42 pneumatic cylinder of pneumatic valve
43 high-pressure side of pneumatic cylinder
44 spring in pneumatic cylinder 42
45 low-pressure side of pneumatic cylinder
46 movable member in pneumatic cylinder 42
47 opening fluidly connecting low-pressure side of pneumatic cylinder with inner volume of lifting tube 36
48 valve seat of pneumatic valve 40
49 opening in high-pressure side of pneumatic cylinder 42
50 flow valve
60 opening fluidly connecting inner volume of lifting tube with inner volume of suction foot
80 ambient air
81 conduit leading to ambient air
82 opening in lifting tube to ambient air
100 vacuum source
200 object to be lifted

1. A vacuum lifting arrangement, comprising: a vacuum source; a suction foot having an upper end, and a lower end configured to engage with an object to be lifted; a lifting tube having a first end and a second end, the first end of the lifting tube being sealingly attached to the upper end of the suction foot, and the second end of the lifting tube being configured to be operatively connected to the vacuum source; a load valve comprising a movable valve member configured to be movable between a closed position, in which closed position the valve member prevents an air flow from an inner volume of the suction foot through the valve into an inner volume of the lifting tube, and an open position, in which open position the valve member enables an air flow from the inner volume of the suction foot into the inner volume of the lifting tube through the valve, which valve is disposed inside the upper end of the suction foot, or, inside the lifting tube, and which valve is configured to be in the open position in an instance of rest of the vacuum lifting arrangement,
characterized in that
the load valve is pneumatic and exhibits a pneumatic cylinder having a high-pressure side configured to stand in fluid connection with ambient air, and a low-pressure side configured to stand in fluid connection with the inner volume of the lifting tube, in which cylinder a movable member is displaced, configured to be movable in a direction between the high-pressure side and low-pressure side, the movable member being operatively connected to the movable valve member, and, in that, an opening is provided fluidly connecting the inner volume of the suction foot with the inner volume of the suction tube.

2. The vacuum lifting arrangement of claim 1, wherein the opening is formed in the movable valve member of the pneumatic load valve, in the valve seat of the pneumatic valve, or in the vicinity of the pneumatic valve.

3. The vacuum lifting arrangement of claim 1, wherein additionally, upstream of the pneumatic load valve, a flow valve configured to connect the inner volume of the lifting tube to ambient air.

4. A vacuum lifting arrangement, comprising: a vacuum source; a suction foot having an upper end, and a lower end configured to engage with an object to be lifted; a lifting tube having a first end and a second end, the first end of the lifting tube being sealingly attached to the upper end of the suction foot, and the second end of the lifting tube being configured to be operatively connected to the vacuum source; a load valve comprising a valve member configured to be movable between a closed position, in which closed position the valve prevents an air flow from an inner volume of the suction foot through the valve into an inner volume of the lifting tube, and in an open position, in which open position the valve enables an air flow from the inner volume of the suction foot into the inner volume of the lifting tube through the valve, which valve is disposed inside the upper end of the suction foot, or, inside the lifting tube, and which valve is configured to be in the open position in an instance of rest of the vacuum lifting arrangement,
characterized in that
the load valve is pneumatic and exhibits a pneumatic cylinder having a high-pressure side configured to stand in fluid connection with ambient air, and a low-pressure side configured to stand in fluid connection with the inner volume of the lifting tube, in which cylinder a movable member is displaced, configured to be movable in a direction between the high-pressure side and low-pressure side, the movable member being operatively connected to the movable valve member, and additionally, in that, upstream of the load valve, a flow valve is provided configured to connect the inner volume of the lifting tube to ambient air.

5. The vacuum lifting arrangement of claim 1, wherein the pneumatic cylinder comprises a spring, biasing the load valve into the open position in a state of non-activity of the vacuum lifting arrangement.

6. The vacuum lifting arrangement of claim 1, wherein the movable valve member and a valve seat of the pneumatic valve are configured to form a tight seal in the closed position of the pneumatic valve.

7. The vacuum lifting arrangement of claim 1, wherein the pneumatic valve is displaced inside the lifting tube in the first end thereof.

8. The vacuum lifting arrangement of claim 1, wherein the lifting tube is flexible and configured to allow for extension and retraction thereof.

9. The vacuum lifting arrangement of claim 3, wherein the flow valve is configured to control the vertical position of the suction foot.

10. The vacuum lifting arrangement of claim 1, wherein the pneumatic valve is configured so that a direction of movement of the movable valve member is essentially parallel with a general longitudinal direction of the lifting tube.

11. The vacuum lifting arrangement of claim 1, wherein the movable member is a piston.

12. The vacuum lifting arrangement of claim 1, wherein the movable member is a membrane.

13. The vacuum lifting arrangement of claim 1, wherein the suction foot is detachable.

14. A lifting tube connected to a suction foot for use in a lifting arrangement of claim 4, the lifting tube having a first end and a second end, the first end being sealingly attached to an upper end of the suction foot, which suction foot has a lower end configured to engage with an object to be lifted, wherein the second end of the lifting tube is configured to be operatively connected to a vacuum source, wherein a load valve comprising a valve member configured to be movable between a closed position, in which closed position the valve prevents an air flow from an inner volume of the suction foot through the valve into an inner volume of the lifting tube, and in an open position, in which open position the valve enables an air flow from the inner volume of the suction foot into the inner volume of the lifting tube through the valve, which valve is disposed inside the upper end of the suction foot, or, inside the lifting tube, and which valve is configured to be in the open position in an instance of ambient pressure in the lifting tube,
characterized in that
the load valve is pneumatic and exhibits a pneumatic cylinder having a high-pressure side configured to stand in fluid connection with ambient air, and a low-pressure side configured to stand in fluid connection with the inner volume of the lifting tube, in which cylinder a movable member is displaced, configured to be movable in a direction between the high-pressure side and low-pressure side, the movable member being operatively connected to the movable valve member.

15. The lifting tube connected to a suction foot of claim 14, for use in a lifting arrangement of claim 1, wherein an opening is provided fluidly connecting the inner volume of the suction foot with the inner volume of the suction tube.

16. The lifting tube connected to a suction foot of claim 14, wherein the suction foot is detachable.
